(19) United States
(12) Patent Application Publication
(10) Pub. No.: US 2026/0109573 A1
(43) Pub. Date: Apr. 23, 2026

(54) BLOCKING DEVICE FOR ELEVATOR SYSTEM AND ELEVATOR SYSTEM

(71) Applicant: Otis Elevator Company, Farmington, CT (US)

(72) Inventors: Wentao Ma, Shanghai (CN); Guoping Pan, Shanghai (CN); Jianye Yang, Shanghai (CN); Yuancheng You, Shanghai (CN)

(21) Appl. No.: 19/360,291

(22) Filed: Oct. 16, 2025

(30) Foreign Application Priority Data
Oct. 18, 2024 (CN) 202411463611.X

(51) Int. Cl. B66B 5/02; B66B 1/34; B66B 3/00; B66B 5/00

(52) U.S. Cl. CPC B66B 5/02; B66B 1/3492; B66B 3/002; B66B 5/0056

(57) ABSTRACT

A blocking device for an elevator system and an elevator system. The blocking device includes: a base, configured to be mounted in an elevator hoistway at a preset distance from a top or bottom of the elevator hoistway; a first signal member and a second signal member, fixed relative to the base; and a rod, pivotally fixed to the base with a first end connected to one end of a rope arranged in the elevator system, and configured such that: when the other end of the rope is operated to tighten the rope to pivot the rod to a first preset position, the rod triggers the first signal member to generate a first signal, and the elevator system is allowed to operate normally in response to the first signal.

### FOREIGN PRIORITY

This application claims priority to Chinese Patent Application No. 202411463611.X, filed Oct. 18, 2024, and all the benefits accruing therefrom under 35 U.S.C. § 119, the contents of which in its entirety are herein incorporated by reference.

### TECHNICAL FIELD OF INVENTION

The present disclosure relates to the technical field of elevators, in particular to a blocking device for an elevator system and an elevator system.

### BACKGROUND OF THE INVENTION

In modern society, installing various types of elevator equipment in high-rise buildings, stations, airports, homes, or private clubs can greatly facilitate people's daily work, life, and travel. Based on the considerations of safe operation, inspection, and maintenance of elevator equipment, there are usually corresponding requirements for the top floor height and pit depth of the elevator hoistway. In addition, blocking devices can be installed at the upper and lower positions inside the elevator hoistway to provide safety and error prevention measures, thereby reducing the risks of injury accidents due to elevators going over the top or underneath.

The present disclosure has found after research that the existing blocking device products may still be optimized and improved in terms of structural configuration, operational performance, installation and maintenance operations, manufacturing and usage costs, and other aspects, especially in application environments with relatively small top floor and/or pit sizes, such as home lifts installed in private residences such as villas.

### SUMMARY OF THE INVENTION

In view of the foregoing, the present disclosure provides a blocking device for an elevator system and an elevator system, so as to solve or at least alleviate one or more of the aforementioned problems and other problems in the prior art, or to provide alternative technical solutions for the prior art.

According to one aspect of the present disclosure, a blocking device for an elevator system is provided, comprising: a base, configured to be mounted in an elevator hoistway at a preset distance from a top or bottom of the elevator hoistway; a first signal member and a second signal member, fixed relative to the base; and a rod, pivotally fixed to the base with a first end connected to one end of a rope arranged in the elevator system, and configured such that: when the other end of the rope is operated to tighten the rope to pivot the rod to a first preset position, the rod triggers the first signal member to generate a first signal, and the elevator system is allowed to operate normally in response to the first signal; when the other end of the rope is operated to release the rope to pivot the rod to a second preset position by gravity, the rod triggers the second signal member to generate a second signal, and the elevator system enters a stopped state in response to the second signal.

In a blocking device for an elevator system according to the present disclosure, optionally, a pivot portion and one or more sliding grooves are provided on the base, the sliding groove is configured with an arcuate contour centered on the pivot portion, and the first end is slidably connected to the sliding groove.

In a blocking device for an elevator system according to the present disclosure, optionally, a triggering portion of the first signal member and a triggering portion of the second signal member are arranged near two ends of the sliding groove respectively, and/or the pivot portion is configured as a hole.

In a blocking device for an elevator system according to the present disclosure, optionally, the blocking device further comprises a counterweight pivotally connected to the first end and slidably connected to the sliding groove, and the rod is connected to the rope through the counterweight, such that when the rope is released, the rod is driven to pivot around the pivot portion to the second preset position through the counterweight.

In a blocking device for an elevator system according to the present disclosure, optionally, the blocking device further comprises one or more display members configured to provide signals for displaying a current state of the blocking device when the first signal member and/or the second signal member are triggered.

In a blocking device for an elevator system according to the present disclosure, optionally, the display member comprises a first display member and a second display member, the first display member is configured to provide a first display signal when the first signal member is triggered to generate the first signal, for displaying that the blocking device is currently in a non-working state, and the second display member is configured to provide a second display signal when the second signal member is triggered to generate the second signal, for displaying that the blocking device is currently in a working state, the first display signal and the second display signal each comprising a visual display signal.

In a blocking device for an elevator system according to the present disclosure, optionally, the blocking device is configured to comprise: a first blocking device, configured to be mounted in the elevator hoistway at a first preset distance from the top, wherein the first display member and the second display member both provide visual display signals with a first feature when the rod of the first blocking device pivots to the first preset position, and provide visual display signals with a second feature when the rod pivots to the second preset position, and wherein when the rod pivots between the first preset position and the second preset position, the first display member and the second display member provide a visual display signal with the second feature and a visual display signal with the first feature, respectively; and/or a second blocking device, configured to be mounted in the elevator hoistway at a second preset distance from the bottom, wherein the first display member and the second display member both provide visual display signals with a third feature when the rod of the second blocking device pivots to the first preset position, and provide visual display signals with a fourth feature when the rod pivots to the second preset position, and wherein when the rod pivots between the first preset position and the second preset position, the first display member and the second display member provide a visual display signal with the fourth feature and a visual display signal with the third feature, respectively.

In a blocking device for an elevator system according to the present disclosure, optionally, the first display member and the second display member each comprise an indicator light, the first feature being the same as the third feature and including the indicator light being turned off, and the second feature being the same as the fourth feature and including the indicator light being turned on.

In a blocking device for an elevator system according to the present disclosure, optionally, the elevator system comprises an operation box mounted in a lobby on the top floor or ground floor of the elevator, the display member is arranged in the operation box, and a rope operator is provided in the operation box, the other end of the rope is fixed to the rope operator to enable the rope to be released or tightened by operating the rope operator.

In a blocking device for an elevator system according to the present disclosure, optionally, the rope operator is provided with a fixing portion for fixing the rope in place after the rope is tightened, the fixing portion comprising a ratchet and a pawl mechanism.

In a blocking device for an elevator system according to the present disclosure, optionally, the operation box comprises a box door having a locking device, the box door closes the operation box to the outside after the locking device is locked, and allows the interior of the operation box to open to the outside after the locking device is unlocked.

In a blocking device for an elevator system according to the present disclosure, optionally, the blocking device is mounted on an elevator guide rail, and/or the first signal member and the second signal member are arranged on two opposite sides or the same side of the base respectively, and/or an elastic member is provided on the second end of the rod opposite to the first end.

In a blocking device for an elevator system according to the present disclosure, optionally, the first signal member and/or the second signal member are detachably mounted on the base, and the first signal member and the second signal member each comprise a safety switch.

In addition, according to another aspect of the present disclosure, an elevator system is provided, comprising: an elevator car which travels along an elevator guide rail in an elevator hoistway under the action of a driving force; a blocking device for an elevator system according to any of the above, mounted in the elevator hoistway at a position at a preset distance from a top or bottom of the elevator hoistway; and a rope, one end of which is connected to a first end of the rod in the blocking device, and the other end of which is arranged in the elevator system for operation to tighten or release the rope.

In an elevator system according to the present disclosure, optionally, the elevator system comprises a home lift.

The blocking device has stable and reliable operational performance, compact structure, easy installation and operation, and can provide effective safety and error prevention measures for the operation, inspection, and maintenance of the elevator system. In particular, it can provide users with a very intuitive, accurate, and comprehensive display of the current state of the blocking device, thereby effectively ensuring and enhancing the safety of the elevator system. The solutions of the present disclosure have a wide range of applications and are particularly suitable for many environments such as home lifts and elevators in private places.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of an elevator system that can adopt an embodiment of a blocking device according to the present disclosure.

FIG. 2 is a three-dimensional structural schematic diagram of an embodiment of a blocking device according to the present disclosure mounted in place in an elevator hoistway, where partial structure of the example of the elevator system is shown.

FIGS. 3 and 4 respectively show the front and rear three-dimensional structures of the embodiment of the blocking device shown in FIG. 2 when it is in a non-working state, where partial elevator guide rails in the example of the elevator system are shown, while the ropes in the blocking device are omitted.

FIGS. 5 and 6 respectively show the front and rear three-dimensional structures of the embodiment of the blocking device shown in FIG. 2 when it is in a working state, where partial elevator guide rails in the example of the elevator system are shown, while the ropes in the blocking device are omitted.

FIG. 7 is a three-dimensional structural schematic diagram of the operation box in the embodiment of the blocking device shown in FIG. 2 when it is opened.

FIG. 8 is a schematic diagram of the installation, layout, and use of the operation box shown in FIG. 7 in the example of the elevator system.

FIGS. 9 and 10 respectively show the front and rear three-dimensional structures of another embodiment of the blocking device according to the present disclosure when it is in a non-working state, where partial elevator guide rails in the example of the elevator system are shown, while the ropes in the blocking device are omitted.

FIGS. 11 and 12 respectively show the front and rear three-dimensional structures of the embodiment of the blocking device shown in FIG. 2 when it is in a working state, where partial elevator guide rails in the example of the elevator system are shown, while the ropes in the blocking device are omitted.

FIG. 13 is an explanatory drawing showing the working states of the two embodiments of the blocking device shown in FIGS. 3 and 9 and the display members therein.

### DETAILED DESCRIPTION OF THE INVENTION

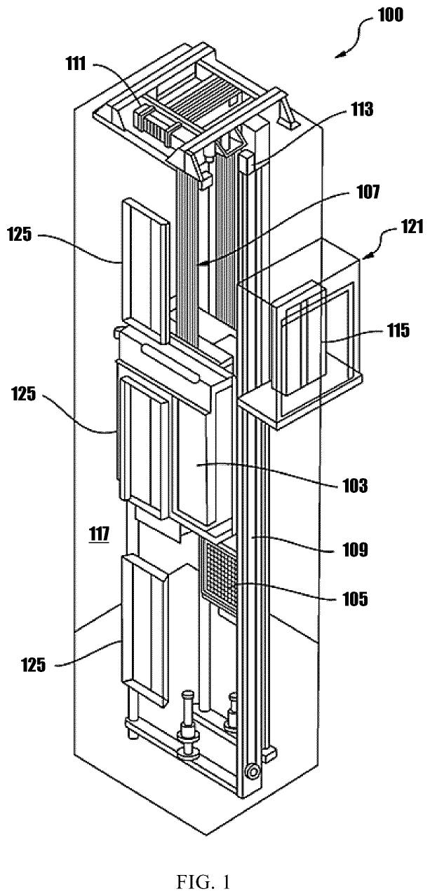

FIG. 1 is a perspective view of an elevator system 100 including an elevator car 103, a counterweight 105, a tension member 107, a guide rail (or rail system) 109, a machine (or machine system) 111, a position reference device 113, and an electronic elevator controller (controller) 115. The elevator car 103 and counterweight 105 are connected to each other by the tension member 107, and travel along the elevator hoistway 127 under the action of driving force. The tension member 107 may include, for example, steel belts (such as coated-steel belts) and/or ropes (such as steel cables). The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111. The machine 111 is configured to control movement between the elevator car 103 and the counterweight 105. Machine 111 may include a motor or similar power unit to provide driving force to elevator system 100, which may adopt a machine-room-less configuration. The position reference device 113 may be arranged in other positions and/or configurations known in the art, such as being mounted on a fixed part at the top of the elevator hoistway 117, such as on a crossbeam 110. The position reference device 113 may be configured to provide position signals related to a position of the elevator car and/or counterweight within the elevator hoistway. The position reference device 113 can employ any device or mechanism for monitoring a position of an elevator car and/or counterweight, as known in the art. For example, it includes but is not limited to an encoder, a sensor, or other component, and may include speed sensing, absolute position sensing, and the like.

The controller 115 may be located in a controller room 121 of the elevator hoistway 117 and may be configured to control the operation of the elevator system 100, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference device 113 or any other desired device or system of this kind. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 100, such as located remotely or in the cloud.

Although specific elevators and components are shown and described herein, FIG. 1 is merely a non-limiting example presented for illustrative and explanatory purposes. It should be noted that other elevator systems can be configured to use the blocking devices disclosed herein, such as for environments with relatively small top floor and/or pit space dimensions, such as home lifts, etc. Additionally, for the sake of simplifying the drawing, identical or similar components and features may only be indicated in one or several locations within the same drawing. Technical terms such as “first”, “second”, “third”, “fourth” are only used for the purpose of distinguishing and are not intended to indicate the order and relative importance thereof. The technical term “connect” (or “engage”) means the realization of connection (or engagement) in a direct or an indirect manner.

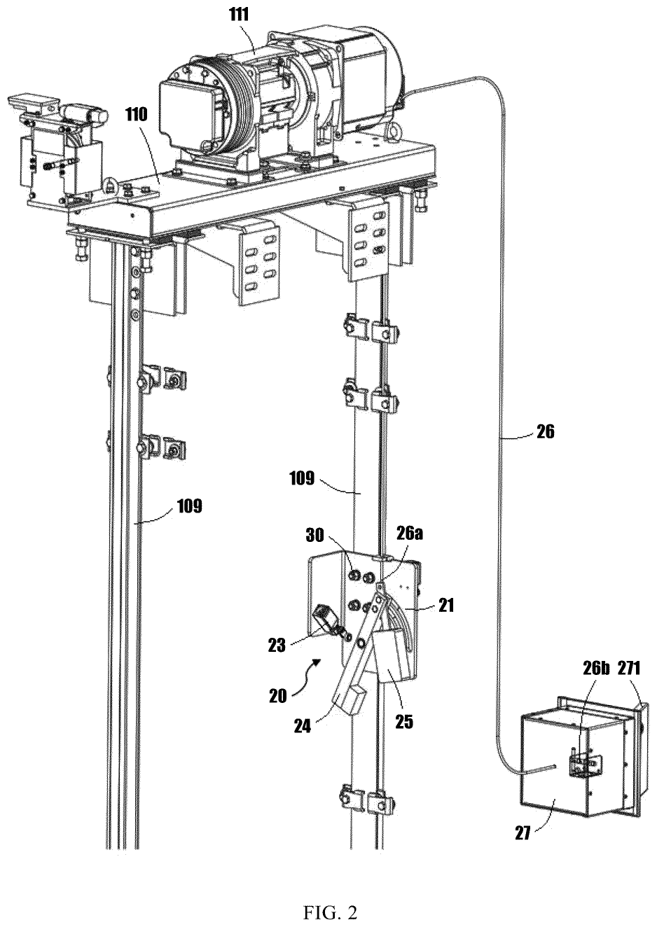

In FIG. 2, the general situation of mounting and arranging an example of a blocking device in the upper space of the elevator hoistway 117 is schematically shown. At the same time, the operation box 27 in the example of the elevator system is also shown in the figure. The operation box 27 can be arranged in a lobby on the top or ground floor of the elevator as shown in FIG. 8, such as on the wall near the elevator hoistway door 108, or can be selected to be arranged in other suitable positions in the elevator system for easy operation and use in practical applications.

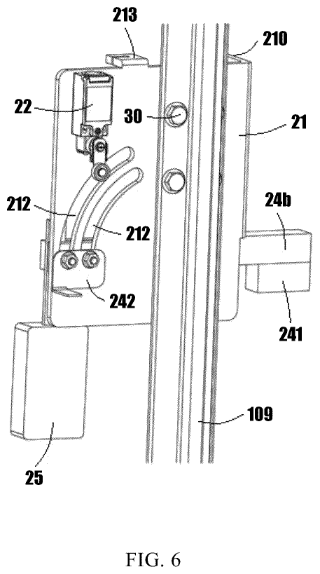

Referring to FIGS. 2 to 6, in the given embodiment, the blocking device 20 may include a base 21, a first signal member 22, a second signal member 23, a rod 24, and a counterweight 25. The base 21 may be made of one or more suitable materials such as steel, iron, metal alloys, etc. as required, and can be made using one or more suitable processes such as casting and stamping. It can be constructed into any shape that meets the requirements of on-site applications, such as a plate shape, or it can have hollow or reinforced rib and other structures to achieve one or more goals such as saving space, reducing weight, and increasing rigidity. According to different application scenarios, any feasible method such as welding connection, detachable connection, etc. can be used to mount the base 21 at a position at a preset distance (such as 1 m, 1.8 m, or other suitable distance) from the top of the elevator hoistway 127, such as fixing it to the elevator guide rail or hoistway wall. FIG. 2 and other drawings exemplarily show that several connecting pieces 30 (such as bolts, screws, etc.) can be used to fix the base 21 in place.

A pivot portion 211 is provided on the base 21, for example, in the form of a hole, and the rod 24 can be fixed to the pivot portion 211 through, for example, a rolling bearing 240, so that the rod 24 can pivot relative to the base 21. It will work together with the first signal member 22 and the second signal member 23 that can be mounted on the base 21.

As shown in FIG. 2, one end portion 26a of the rope 26 configured in the example of the elevator system can be connected to the rod 24. More specifically, in this embodiment, the rope 26 is connected to the rod 24 through a counterweight 25, and the counterweight 25 and the first end portion 24a of the rod 24 are connected to provide additional gravitational force, etc. With the help of the gravitational force, it is possible to cause the rod 24 to pivot around the pivot portion 211 while releasing the rope 26 by operating the other end portion 26b of the rope 26, thereby changing the working state of the blocking device 20. In addition, by using the above gravitational force, even in abnormal situations where the rope 26 breaks, the blocking device can be continuously and reliably maintained in the working trigger state. This mechanism can effectively ensure and improve the safety and reliability of the system.

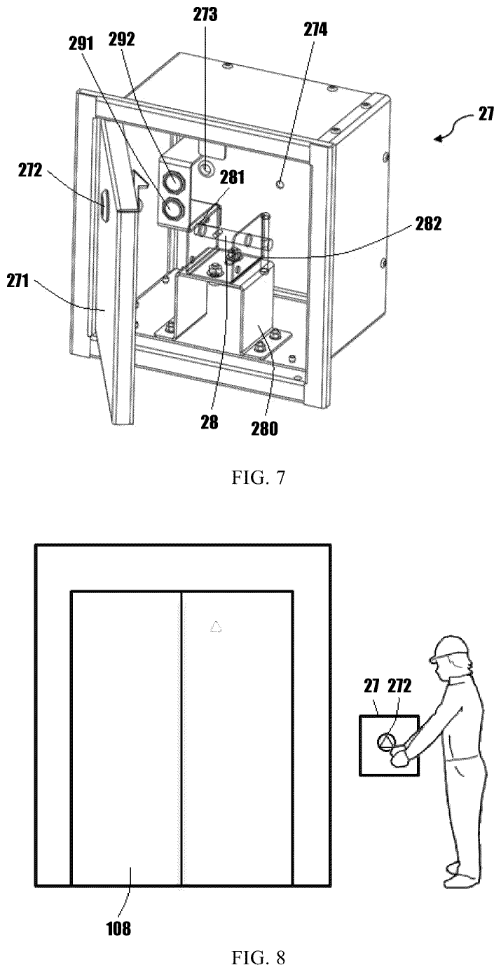

As an optional scenario, a guide portion 213 can be provided on the base 21, which can be in the form of, for example, a protruding structure with perforations for ropes to pass through, so as to better guide and ensure the connection between the rope 26 and the counterweight 25 and rod 24, without causing adverse effects such as interference on the base 21 and other possible components. In addition, the other end portion 26b of the rope 26 can be connected and fixed to the rope operator 28 that can be arranged inside the operation box 27. For example, as shown in FIG. 7, a hole 274 is provided on the operation box 27 for the rope 26 to be connected to the inside of the box. A locking portion 281 can be provided on the rope operator 28 to fix the rope 26 in place after it is tightened, and the rope 26 can be tightened or released by operating the operating portion 282 on the rope operator 28. As an example, the locking portion 281 can adopt any suitable structure such as a ratchet and a pawl mechanism, and the operating portion 282 can adopt any suitable structure such as a handle for manual operation by the user. In one or some embodiments, the rope operator 28 may be configured to use power operation, such as configuring a motor with a control switch, to achieve tightening or releasing operations of the rope 26. Rope 26 can be made of suitable materials such as steel wire rope, and its specific length, cross-sectional shape, and size can be configured according to actual application requirements.

As used herein, in various embodiments, the rod 24 can be configured to trigger the first signal member 22 and the second signal member 23 to generate the first signal S1 and the second signal S2, respectively. The elevator system 100 can respond to the two different signals mentioned above, and control the elevator to maintain normal operation or enter a stopped state accordingly.

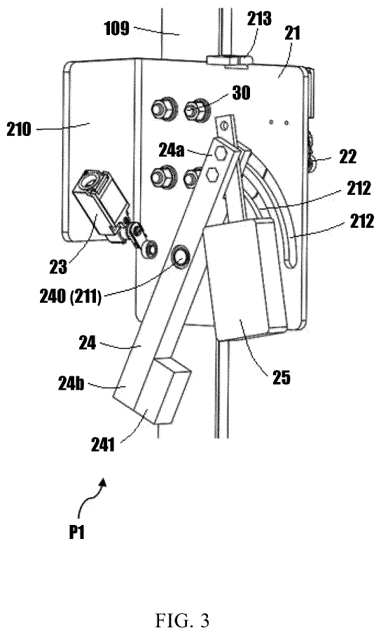

Specifically, when the elevator system is in normal use, the rope 26 can be tightened to cause the rod 24 to pivot around the pivot portion 211 to reach a first preset position P1 (FIG. 3). The rod 24 triggers the first signal member 22, at which point the first signal member 22 generates the first signal S1. In this way, the elevator system can determine based on the first signal S1 and maintain the normal operating state of the system, such as allowing the elevator car 103 to run along the elevator guide rail 109 at the set normal speed. The blocking device 20 in the above scenario can be referred to as being in a non-working state herein.

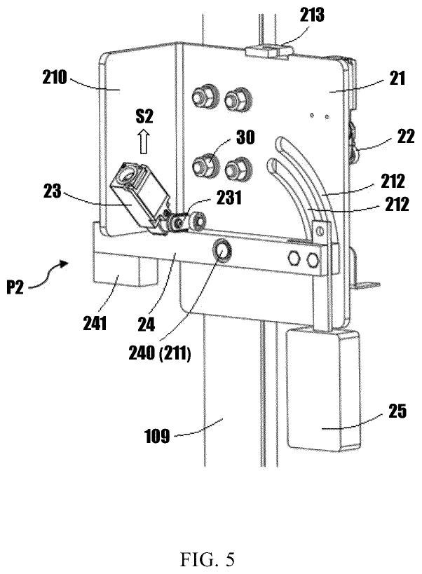

In the case where equipment inspection, component maintenance and replacement are required for the elevator system, the rope 26 can be released. At this point, the rod 24 can be made to pivot around the pivot portion 211 to reach a second preset position P2 (FIG. 5) by means of the gravity of the counterweight 25. The rod 24 will trigger the second signal member 23 to generate the second signal S2, and the elevator system can enter a stopped state based on the determination of the second signal S2. In the stopped state, the elevator allows for the operation of car roof maintenance. For example, at this point, the elevator car 103 can be controlled to stop running or can only run at a set relatively low inspection speed, thereby effectively ensuring the personal safety of maintenance personnel and avoiding equipment damage. The blocking device 20 in the above scenario can be referred to as being in the working state herein.

In order to avoid or reduce unexpected injuries, an elastic member 241, which can be made of, for example, one or more suitable materials such as rubber, can be optionally provided at the second end 24b of the rod 24, to provide certain protection to the external environment, especially when the rod 24 pivots and falls downward from a relatively high position. In addition, a side structure 210 can be optionally mounted on the base 21, which can on the one hand make full use of the on-site space to mount the second signal member 23, and on the other hand be used to cooperate with the rod 24 located at the second preset position P2 to provide contact limit or the like.

As shown in FIG. 3, as an optional configuration, one or more sliding grooves 212 can be provided on the base 21. For example, the sliding groove 212 can be configured to have an arcuate contour, which is constructed with the pivot portion 211 (such as pivot hole, etc.) on the base 21 as the center. The first end 24a of the rod 24 can be slidably connected to the groove 212, for example, by passing one or more connecting pieces 243 through the corresponding grooves 212 and connecting the first end 24a of the rod 24 with the counterweight 25 and the joint piece 242 arranged on the other side of the base 21, so as to better define the pivot movement trajectory of the rod 24 and other components, thus making the overall operational performance of the device more stable and reliable. In addition, as an optional configuration, the triggering portion 221 of the first signal member 22 and the triggering portion 231 of the second signal member 23 can be arranged near the two ends of the sliding groove 212 respectively, in order to cooperate with the rod 24 to perform corresponding triggering operations on them when the rod 24 reaches the above position P1 or P2.

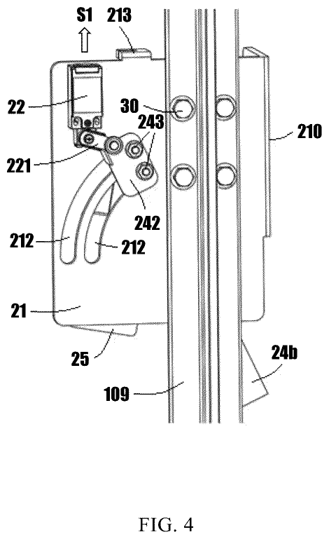

For the first signal member 22 and the second signal member 23, they can be in the form of any suitable component such as a safety switch. Although the example shown in FIGS. 4 and 5 shows that corresponding signals can be generated through triggering by contacting the first signal member 22 and the second signal member 23 with the rod 24. In one or some other embodiments, however, non-direct contact signal triggering methods are also allowed, such as configuring signal triggers in the form of infrared radiation. The present disclosure does not make any restrictions in this regard.

As mentioned earlier, the first signal S1 and the second signal S2 generated by the first signal member 22 and the second signal member 23 are used to provide the elevator system with state analysis and processing. For example, they can be input to a controller 115 for data analysis. Of course, additionally configured processors, units, or modules can also be used for corresponding processing. The latter can be optionally arranged at any suitable location in the elevator system or arranged remotely. As used herein, in various embodiments, one or more display members can be configured in the blocking device 20 to display the current state of the blocking device 20, thereby helping users to be informed of the current working situation in a more timely and accurate manner, thus enhancing system safety performance, especially effectively protecting personal and equipment safety, and avoiding accidents or incidents.

The above display members can be in one or more information display forms such as lighting, sound, graphics, text, etc. as required to transmit the current working state information of the blocking device 20 to the outside, such as using carriers such as LED lights, buzzers, display screens alone or in combination.

As an example, a first display member 291 and a second display member 292 can be configured. The former provides a first display signal to indicate that the blocking device 20 is currently in a non-working state when the first signal member 22 is triggered to generate the first signal S1, while the latter provides a second display signal to indicate that the blocking device 20 is currently in a working state when the second signal member 23 is triggered to generate the second signal S2.

For example, as shown in FIG. 7, the first display member 291 and the second display member 292 can be optionally arranged inside the operation box 27, where they can be in the form of indicator lights such as LEDs. In FIG. 7, it is exemplarily shown that a hole 273 is provided on the operation box 27 for the first display member 291 and the second display member 292 for communication link to the outside. Of course, in one or some embodiments, such display members can also use wireless communication for data transmission.

The first display member 291 and the second display member 292 can be combined and configured to provide visual display signals with different characteristics based on the different current states of the blocking device 20, making it easier, more intuitive, and comprehensive for users to grasp the situation. For example, if the configuration adopts the form of indicator lights, the first display member 291 and the second display member 292, which are usually kept turned off, can only be turned on together when the blocking device 20 is in the working state. That is, when the blocking device 20 is in the non-working state, the first display member 291 can be kept turned off. When the blocking device 20 is in the intermediate transition state between the non-working state and the working state, the first display member 291 can be turned on and the second display member 292 can be turned off. Until the device enters the working state, the second display member 292 can be turned on again. In this way, the display process of the above state information is very clear and explicit, which is very easy for users to understand and grasp, and not prone to errors.

It should be appreciated that, corresponding to the distinguishing visual display modes of turning on and off as mentioned above, those skilled in the art can also use various possible feature forms such as different colors (such as red or green), flashing frequencies (such as high or low frequency flashing), etc. separately or in combination, to achieve the technical effect of displaying different current states of the blocking device 20 in a differentiated manner.

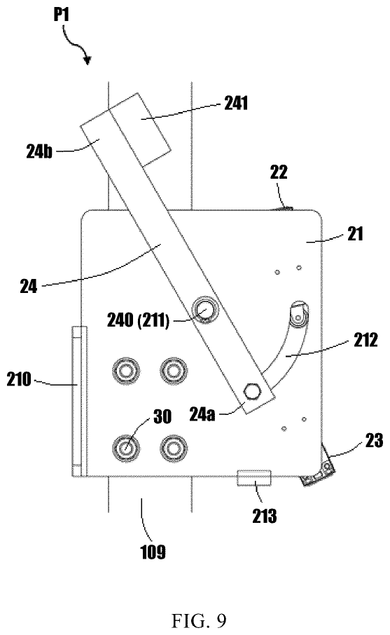

With continued reference to FIGS. 9 to 12, these figures illustrate the general structure and application scenario of another embodiment of the blocking device according to the present disclosure. Unless otherwise specified, some structures in this embodiment may be essentially the same or similar to the aforementioned embodiments.

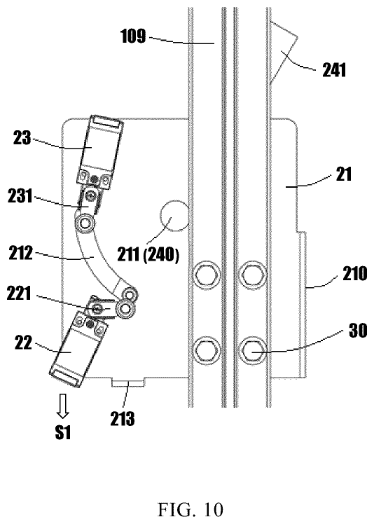

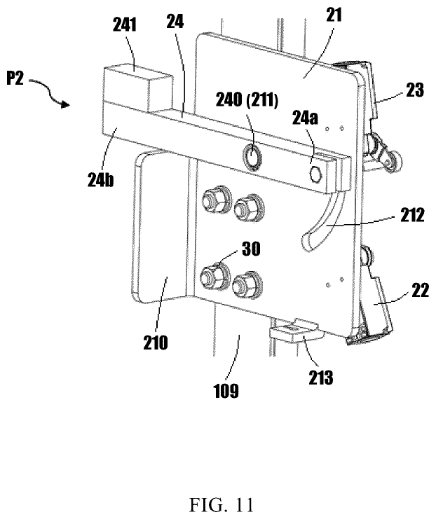

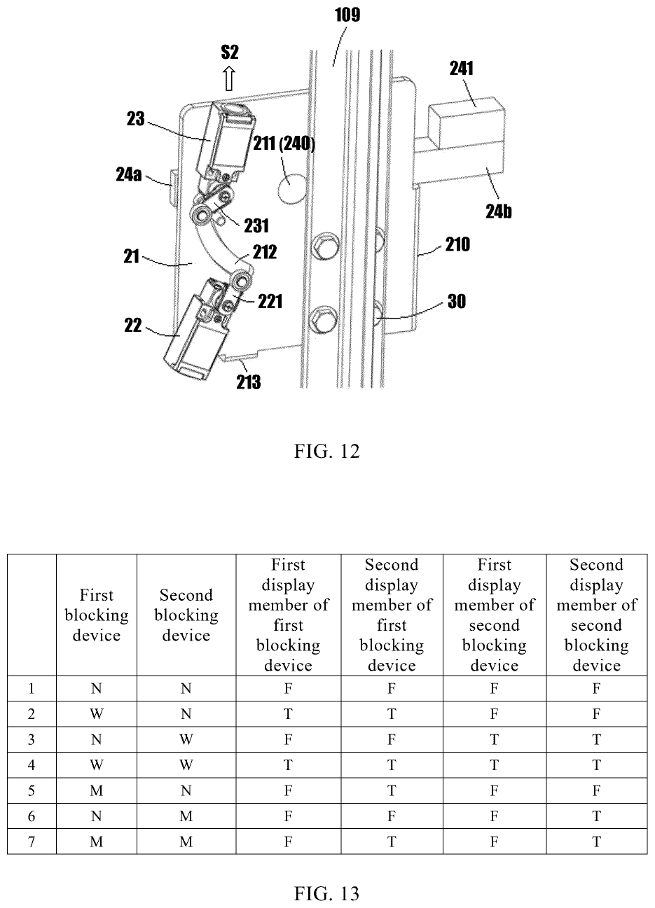

FIGS. 9 and 10 show the situation of the embodiment of the blocking device when it is currently in a non-working state, while FIGS. 11 and 12 further illustrate the situation when it is in a working state. As shown in these figures, it is not necessary to arrange a counterweight 25 in the blocking device, while the end portion 26a of the rope 26 can be directly connected to the first end 24a of the rod 24. The gravity effect of the rod 24 can be utilized to achieve the pivot of the rod 24 from the first preset position P1 to the second preset position P2 after the rope 26 is released. For example, the distance between the second end 24b of the rod 24 and the pivot portion 211 can be made to be greater than the distance between the first end 24a and the pivot portion 211, thereby forming a relatively larger gravity torque acting on the rod 24 to pivot it from the above position P1 to position P2. In addition, only one arcuate groove 212 can be configured on the base 21, which can simplify the structure and reduce manufacturing costs. Furthermore, the first signal member 22 and the second signal member 23 can be configured to be located on the same side of the base 21 at the same time. For example, they can be optionally arranged on one side of the base 21, and the rod 24 can be arranged on the other side of the base 21.

According to different application requirements, the blocking device according to the present disclosure allows for various possible implementation forms, from which specific applicable embodiments can be selected and arranged at suitable positions in the elevator system as required. For example, the example of the blocking device shown in FIG. 3 can be mounted in the elevator hoistway at a position at a first preset distance from the top, and the operation box can be arranged in the lobby on the top floor of the elevator (such as on the wall of the room on the top floor of a private residence). For another example, the example of the blocking device shown in FIG. 9 can be mounted in the elevator hoistway at a position at a second preset distance from the bottom, where the second preset distance can be the same or different from the first preset distance mentioned above, and the operation box can be arranged in the lobby on the ground floor of the elevator (such as on the wall of the basement of a private residence). This can fully adapt to the site conditions and flexibly configure and utilize the blocking device of the present disclosure, thus achieving the good effects of effectively ensuring the safety of personnel and equipment, reducing or even eliminating risks, and enhancing the safety performance of the system.

Based on the optional configuration scenarios discussed above, it is possible to provide reliable protective measures in a convenient and safe manner for inspecting, repairing, and operating the top floor and pit of the elevator system by arranging the same or different blocking devices in the upper and lower parts of the elevator hoistway. In particular, the current states of the system can be obtained in a timely, accurate, and intuitive manner through the display members in the above blocking devices.

In FIG. 13, a table is used to illustrate in detail the situation of different states of the first and second blocking devices respectively mounted at the upper and lower positions inside the elevator hoistway during use, wherein the characters N, W, and M respectively represent that the blocking device is currently in a non-working state (the first signal member has been triggered and the second signal member has not been triggered), a working state (the second signal member has been triggered and the first signal member has not been triggered), and an intermediate transition state between the above two states (the first and second signal members have not been triggered). The characters F and T respectively represent that the corresponding display members in the blocking device display in a matching manner that the blocking device is currently in a non-working state and a working state with a first feature (e.g. turn off the indicator light), a second feature (e.g. turn on the indicator light). When in the intermediate transition state, the first display member is made to display with the first feature, i.e., corresponding to the character T.

For example, when it is necessary to inspect, repair, or perform other operations on the device located at the top of the elevator hoistway or car roof, the staff can reach the top floor position and then operate the operation box 27. For safety reasons, a locking device 272 (such as a triangle lock or electronic control lock) is configured for the operation box 27. When the operation box 27 is closed to the outside, the staff must first unlock the lock 272, open the box door 271, and then operate the rope operator 28, which for example can be mounted on the bracket 280, to release the rope 26. That is, the first blocking device shown in FIG. 13 will enter the working state (represented by the character W) from the original non-working state (represented by the character N). At this point, both the first display member and the second display member are changed from the original first feature (represented by character F) to the second feature (represented by character T).

The second blocking device shown in FIG. 13 has the same or similar situation as described above with respect to the first blocking device. In addition, the situation listed in FIG. 13 where both the first blocking device and the second blocking device are in the working state (item 4) is also the same, which will not be repeated here.

In this way, by combining the information displayed on the respective display members in the first and second blocking devices, corresponding to the situation shown in item 1 of FIG. 13, it indicates that neither the first blocking device nor the second blocking device has entered a working state, at which point the elevator system is operating normally and cannot enter a stopped state. In the situations shown in items 2-7, it indicates that the first blocking device or the second blocking device has entered a working state or is in an intermediate transition state, at which point the elevator system enters a stopped state. For example, at this point, the elevator car is only allowed to operate at an inspection speed or is prohibited from operating. For example, in the situations shown in items 3 and 5-7, the car can be prohibited from operating. This can be controlled through the elevator system according to actual requirements or corresponding national or international industry regulations.

In practical use, by viewing the corresponding display information of the display members configured in the first and second blocking devices, the current actual working state inside the device can be obtained in a very intuitive and accurate manner, and then the correct processing can be made accordingly. For example, only when the display information of these display members indicates that both the first and second blocking devices have entered the working state, can the staff be allowed to enter the elevator hoistway for inspection, maintenance and other work. This can effectively ensure the personal safety of the staff and avoid accidents or incidents.

It should be noted that for the blocking devices arranged at different positions in the elevator system, such as the first blocking device and the second blocking device discussed in the above examples, the display members therein are allowed to use the same or different information display methods. For example, in the case where both the first display member and the second display member are configured, their respective first display members (or second display members) can provide visual display signals with different characteristics to the outside when facing the same current state of the device, such as allowing the illustratively configured indicator lights of the first display member to be turned on or off for differentiated display, and allowing the illustratively configured indicator lights of the first display member to be lit in different colors such as red or green for differentiated display, and so on, thus better meeting various requirements that may exist in different application scenarios.

A blocking device for an elevator system and an elevator system according to the present disclosure have been described above in detail by way of examples only. These examples are merely used to illustrate the principles and embodiments of the present disclosure, rather than limiting the present disclosure. Various modifications and improvements can be made by those skilled in the art without departing from the scope of the present disclosure. Therefore, all equivalent technical solutions should fall within the scope of the present disclosure and be defined by the claims of the present disclosure.

What is claimed is:

1. A blocking device for an elevator system, comprising:
a base, configured to be mounted in an elevator hoistway at a preset distance from a top or bottom of the elevator hoistway;
a first signal member and a second signal member, fixed relative to the base; and
a rod, pivotally fixed to the base with a first end connected to one end of a rope arranged in the elevator system, and configured such that: when the other end of the rope is operated to tighten the rope to pivot the rod to a first preset position, the rod triggers the first signal member to generate a first signal, and the elevator system is allowed to operate normally in response to the first signal; when the other end of the rope is operated to release the rope to pivot the rod to a second preset position by gravity, the rod triggers the second signal member to generate a second signal, and the elevator system enters a stopped state in response to the second signal.

2. The blocking device for an elevator system according to claim 1, wherein a pivot portion and one or more sliding grooves are provided on the base, the sliding groove is configured with an arcuate contour centered on the pivot portion, and the first end is slidably connected to the sliding groove.

3. The blocking device for an elevator system according to claim 2, wherein a triggering portion of the first signal member and a triggering portion of the second signal member are arranged near two ends of the sliding groove respectively, and/or the pivot portion is configured as a hole.

4. The blocking device for an elevator system according to claim 2, wherein the blocking device further comprises a counterweight pivotally connected to the first end and slidably connected to the sliding groove, and the rod is connected to the rope through the counterweight, such that when the rope is released, the rod is driven to pivot around the pivot portion to the second preset position through the counterweight.

5. The blocking device for an elevator system according to claim 1, wherein the blocking device further comprises one or more display members configured to provide signals for displaying a current state of the blocking device when the first signal member and/or the second signal member are triggered.

6. The blocking device for an elevator system according to claim 5, wherein the display member comprises a first display member and a second display member, the first display member is configured to provide a first display signal when the first signal member is triggered to generate the first signal, for displaying that the blocking device is currently in a non-working state, and the second display member is configured to provide a second display signal when the second signal member is triggered to generate the second signal, for displaying that the blocking device is currently in a working state, the first display signal and the second display signal each comprising a visual display signal.

7. The blocking device for an elevator system according to claim 6, wherein the blocking device is configured to comprise:
a first blocking device, configured to be mounted in the elevator hoistway at a first preset distance from the top, wherein the first display member and the second display member both provide visual display signals with a first feature when the rod of the first blocking device pivots to the first preset position, and provide visual display signals with a second feature when the rod pivots to the second preset position, and wherein when the rod pivots between the first preset position and the second preset position, the first display member and the second display member provide a visual display signal with the second feature and a visual display signal with the first feature, respectively; and/or
a second blocking device, configured to be mounted in the elevator hoistway at a second preset distance from the bottom, wherein the first display member and the second display member both provide visual display signals with a third feature when the rod of the second blocking device pivots to the first preset position, and provide visual display signals with a fourth feature when the rod pivots to the second preset position, and wherein when the rod pivots between the first preset position and the second preset position, the first display member and the second display member provide a visual display signal with the fourth feature and a visual display signal with the third feature, respectively.

8. The blocking device for an elevator system according to claim 7, wherein the first display member and the second display member each comprise an indicator light, the first feature being the same as the third feature and including the indicator light being turned off, and the second feature being the same as the fourth feature and including the indicator light being turned on.

9. The blocking device for an elevator system according to claim 5, wherein the elevator system comprises an operation box mounted in a lobby on the top floor or ground floor of the elevator, the display member is arranged in the operation box, and a rope operator is provided in the operation box, the other end of the rope is fixed to the rope operator to enable the rope to be released or tightened by operating the rope operator.

10. The blocking device for an elevator system according to claim 9, wherein the rope operator is provided with a fixing portion for fixing the rope in place after the rope is tightened, the fixing portion comprising a ratchet and a pawl mechanism.

11. The blocking device for an elevator system according to claim 9, wherein the operation box comprises a box door having a locking device, the box door closes the operation box to the outside after the locking device is locked, and allows the interior of the operation box to open to the outside after the locking device is unlocked.

12. The blocking device for an elevator system according to claim 1, wherein the blocking device is mounted on an elevator guide rail, and/or the first signal member and the second signal member are arranged on two opposite sides or the same side of the base respectively, and/or an elastic member is provided on the second end of the rod opposite to the first end.

13. The blocking device for an elevator system according to claim 12, wherein the first signal member and/or the second signal member are detachably mounted on the base, and the first signal member and the second signal member each comprise a safety switch.

14. An elevator system, comprising:
an elevator car which travels along an elevator guide rail in an elevator hoistway under the action of a driving force;
a blocking device for an elevator system according to claim 1, mounted in the elevator hoistway at a position at a preset distance from a top or bottom of the elevator hoistway; and
a rope, one end of which is connected to a first end of the rod in the blocking device, and the other end of which is arranged in the elevator system for operation to tighten or release the rope.

15. The elevator system according to claim 14, wherein the elevator system comprises a home lift.
